(19) United States
(12) Patent Application Publication
(10) Pub. No.: US 2024/0066818 A1
(43) Pub. Date: Feb. 29, 2024

(54) DEVICE AND METHOD FOR PRODUCING AND TREATING A CONTAINER OF A MATERIAL COMPRISING FIBERS IN A MOLD

(71) Applicant: Krones AG, Neutraubling (DE)

(72) Inventors: Frank WINZINGER, Regensburg (DE); Matthias WAHL, Langquaid (DE); Yvette FREESE, Regensburg (DE); Andreas HIPPEL, Wörth (DE); Joerg ZACHARIAS, Koefering (DE)

(21) Appl. No.: 18/455,412

(22) Filed: Aug. 24, 2023

(30) Foreign Application Priority Data
Aug. 25, 2022 (DE) 102022121467.2

(51) Int. Cl. B29D 22/00; B67C 7/00

(52) U.S. Cl. CPC B29D 22/003; B67C 7/0073; B29K 2105/0058

(57) ABSTRACT

A device for producing a container from a material comprising fibers and for treating the container, wherein the device comprises a mold, a first apparatus for performing at least one production step for producing the container from the material comprising fibers in the mold, and a second apparatus for performing at least one treatment step for treating the container, and wherein the second apparatus is configured to treat the container in the mold.

The invention relates to a device for producing and treating a container of a material comprising fibers in a mold and to a corresponding method in accordance with the independent claims.

### PRIOR ART

It is known from prior art to produce containers from material comprising fibers, for example pulp. For this purpose, a suspension of material comprising fibers is introduced into a perforated mold or a mold designed as a grid. By subjecting positive pressure to the suspension adhering to the inside of the mold or by subjecting negative pressure to the outside of the mold, fixation of the fibers to the inside of the mold can be achieved and at the same time the liquid phase can be removed from the suspension. To achieve complete curing of the container, it is typically subjected to additional heat. The mold can subsequently be opened and the container removed. The container produced in this way can be transferred to a treatment machine, which is configured, for example, to fill or close the container.

WO2019/034707, for example, discloses a method for producing a container from material comprising fibers. The method comprises forming a container blank in a first negative mold. The subsequent forming of the container blank into a container takes place in a second negative mold, which is configured in particular for hot pressing. Further, the publication discloses transferring the container produced in this manner to another machine for coating, filling or sealing.

EP 3 642 414 again discloses a method for producing containers from material comprising fibers, wherein the container is made from a pulp mixture in a mold. In a downstream treatment step, the produced container can be coated.

### TECHNICAL OBJECT TO BE ACHIEVED

With regard to the prior art, the technical problem to be solved by the present invention is to simplify the production and treatment process for containers of a material comprising fibers.

### Achievement

To solve this object, the invention provides a device for producing and treating a container of a material comprising fibers in a mold in accordance with independent claim 1 and a corresponding method in accordance with independent claim 8. Preferred embodiments of the invention are set forth in the dependent claims.

The device according to the invention for producing a container from a material comprising fibers and for treating the container comprises a mold, first apparatus for performing at least one production step for producing the container from the material comprising fibers in the mold, and second apparatus for performing at least one treatment step for treating the container, wherein the second apparatus is configured to treat the container in the mold.

Since the container can be produced and treated in a mold by means of the device according to the invention, it is not necessary to open the mold, remove the container from the mold, or transfer the container to another mold or another device for treating. With the device according to the invention, it is thus possible not only to make the production and treatment process more efficient in terms of time and to achieve a higher container throughput, but also to realize a more compact design of the device for producing and treating containers, since it is not necessary to transport or transfer the mold or container to at least one further device for performing a further process step.

Production of a container can be understood as a completion of the final shape of the container, in particular without closure and label.

The container made of material comprising fibers and treated by the device is preferably designed as a bottle used in the beverage industry. However, the container is not limited to this type of embodiment. Rather, the device may also be configured for the production and treatment of cups, cans or tubes of material comprising fibers, such as those used in the beverage, pharmaceutical, healthcare or food industries, or any container of material comprising fibers suitable for containing a liquid or pasty medium.

At the beginning of the production process, the material comprising the fibers is typically in the form of a suspension, which comprises a binder and water in addition to the fibers. For example, the suspension may comprise a water content of 0.1% to 99.9%. By placing the suspension in a mold and applying heat to the mold and/or applying a positive or negative pressure to the mold, the material comprising fibers can be cured and a container can be created. Depending on the shape used, containers of different types can be created, as described above. For example, the material comprising fibers may comprise or be pulp, which is also known as papier-mâché. The fibers are preferably paper fibers. However, it can also be any other material comprising fibers suitable for producing a container.

By a production step is meant a step associated with the forming of the container from the suspension of material comprising fibers and its curing. This includes, for example, introducing the suspension of material comprising fibers into the mold and subsequently curing the suspension of material comprising fibers in the mold. Any further process step not related to the introduction of the suspension and its curing is to be understood as a treatment step. The treatment step may comprise, for example, coating the container, filling the container, sterilizing or cleaning the container, labeling and/or printing the container, and/or sealing the container.

In one embodiment, the first and second apparatus may be movable in a plane extending perpendicular to a longitudinal axis of the mold to be alternately positioned above the mold to perform the production step and the treatment step. This can provide flexibility in the alignment of the first and second apparatus with respect to the mold, and eliminate the need to transport or transfer the mold from the first to the second apparatus. This should also be understood to mean when only one component of the movement is perpendicular; in other words, it should also be understood to include oblique movements, for example at an angle of 45°.

In one embodiment, there may be provided a transport unit comprising the first apparatus and the second apparatus, and wherein the transport unit may be rotated about an axis parallel to the longitudinal axis and/or wherein the transport unit may be displaced along an axis not parallel to the longitudinal axis to be alternately positioned over the mold to perform the production step and the treatment step. In the first of the two embodiments, the transport unit may be configured, for example, as a turret head rotatable about an axis of rotation. By rotating the turret head, the first or second apparatus can be placed over the mold, wherein the space required to provide the first and second apparatus is reduced. The second embodiment, on the other hand, allows flexible positioning of the first and second apparatuses in a structurally simple manner, in particular without rotary distributors in the area of the mold.

In one embodiment, the first apparatus may comprise a first component for dispensing a suspension of material comprising fibers into the mold and a second component for curing the suspension of material comprising fibers dispensed into the mold. Introduction of the suspension and curing of the container can thus be carried out in the same mold.

In one embodiment, the first and second apparatuses can be moved independently of each other, in particular by separate drives, in particular motors.

In one embodiment, at least one apparatus is moved by a robotic arm.

In one embodiment, the first component may comprise a nozzle for discharging the suspension of material comprising fibers into the mold and/or the second component for curing the suspension of material comprising fibers may comprise a first subcomponent for exposure to UV radiation, infrared radiation, electron radiation, alternating magnetic fields, and/or a plasma, wherein the first subcomponent may be configured to subject positive pressure to the interior of the mold. By discharging the suspension of the material comprising fibers by means of a nozzle, a uniform discharge of the suspension can be achieved. Treating with UV radiation, infrared radiation, electron radiation, alternating magnetic fields and/or a plasma is not only more energy efficient than curing by means of hot air, but also prevents the container from shrinking during the curing process. In addition, germs that may be present inside the container can be efficiently killed. Subjecting positive pressure to the interior of the mold ensures that the suspension of material comprising fibers is securely fixed to the wall of the mold and also has a beneficial effect on the curing process, since the liquid phase of the suspension can be forced out of the mold by means of the overpressure.

In one embodiment, the mold may comprise an opening and the nozzle and the first subcomponent may be configured to be guided through the opening into the interior of the mold. By introducing the nozzle and the first subcomponent into the interior of the mold, uniform distribution and curing of the suspension of material comprising fibers can be achieved inside the mold. This makes it possible to produce high-quality containers with a uniform wall thickness distribution.

In one embodiment, the second component may comprise a bladder or preform which may be inserted into the interior of the mold, and which may be may be subjected to positive pressure to cure the suspension introduced into the mold. By subjecting positive pressure to the bladder or preform in the mold, a liquid phase contained in the suspension of material comprising fibers can be removed particularly efficiently and the material comprising fibers can be pressed out to form a container.

In one embodiment, the container produced by the first apparatus may be transferred from the first apparatus to the second apparatus by means of the bladder or preform inserted into the interior of the container. This enables particularly gentle gripping and transferring of the containers produced, thus avoiding damage to the containers. Further, a mandrel or equivalent device for gripping and transferring the containers is not required.

In one embodiment, the second apparatus for performing at least one treatment step may comprise a third component for applying a coating to the container, a fourth component for filling the container with a liquid, a fifth component for labeling the container, and/or a sixth component for sealing the container. Optionally, the second apparatus may comprise a seventh component for sterilizing and/or cleaning the container and/or an eighth component for applying a second coating to the container.

For example, the coating can affect the barrier properties of the container to water and/or oils so that softening of the container by the product can be avoided. For example, the coating may be polyethylene or comprise polyethylene. The second coating may comprise silicon, for example, and may provide a barrier to the escape of carbon dioxide or the entry of oxygen.

Both coatings can be an internal coating.

Alternatively, one coating may be an inner coating and the other an outer coating of the container.

Two components or two apparatuses may be arranged coaxially to one another in one embodiment such that no movement with a horizontal component (=horizontal portion of the movement vector) perpendicular to the longitudinal mold axis is necessary to switch between production and treatment.

In one embodiment, a plurality of molds are arranged on a rotating wheel along the circumference thereof. The wheel can move intermittently or continuously.

For example, the label may be a permeable label so that the liquid phase of the suspension of material comprising fibers can be guided out of the mold through the permeable label during the drying process. Since the second apparatus can be configured to perform different treatment steps, further devices for treating are in principle not necessary, which enables a space-saving design of the device for producing and treating.

The device may comprise a mixing vessel for mixing fibers with other components, in particular a liquid, in particular water, and in particular a feed line from the mixing vessel to the mold or to the first apparatus. A pump can be arranged along the feed line.

The device may further comprise a filler for filling a beverage into the container, if not already integrated into the second apparatus.

The apparatus may comprise a labeling machine for labeling the container with a label and/or a printer for printing the container with ink or paint or the like, if not already integrated into the second apparatus.

The device may further comprise a packer for packing the container with additional containers.

The device can further comprise a palletizer for palletizing containers or the packs.

The device may comprise a transport system capable of transporting the containers from the mold to one or more of said filler, labeler, packer, and/or palletizer. The transport system may comprise conveyors and/or grippers, in particular rotating transport stars with grippers.

The method according to the invention for producing a container from a material comprising fibers in a mold and for treating the container comprises at least one production step performed by a first apparatus and at least one treatment step performed by second apparatus, wherein the container is in the mold when the treatment step is performed. Since the container does not have to be removed from the mold to perform the treatment steps, the method allows containers to be produced and treated in a shorter time and a high container throughput to be achieved.

In one embodiment of the method, the first apparatus and the second apparatus are configured to move in a plane extending perpendicular to a longitudinal axis of the mold to be alternately positioned over the mold to perform the production step and the treatment step. This allows flexible placement of the first and second apparatus above the mold.

In one embodiment of the method, a transport unit may be provided comprising the first apparatus and the second apparatus and wherein the transport unit is rotated about an axis extending parallel to the longitudinal axis of the mold and/or wherein the transport unit is moved along an axis not extending parallel to the longitudinal axis of the mold to alternately position the first apparatus and the second apparatus over the mold to perform the production step and the treatment step. The shortest possible travel distances achieved in this way allow efficient placement of the first and second apparatus above the mold and increase the container throughput achieved.

In one embodiment of the method, the production step comprises discharging a suspension of material comprising fibers into the mold by means of a first component of the first apparatus and curing the suspension of material comprising fibers in the mold by means of a second component of the first apparatus. This eliminates the need to remove the container from the mold and to feed it to a drying facility, which has a favorable effect on the quality of the container.

In one embodiment of the method, for discharging the suspension of material comprising fibers, a nozzle is guided through an opening of the mold into the interior of the mold, and for curing the suspension of material comprising fibers, a first subcomponent of the first apparatus for exposure to UV radiation, infrared radiation, electron radiation, alternating magnetic fields, and/or a plasma, is guided through the opening into the interior of the mold, wherein the interior of the mold is subjected to positive pressure by the first subcomponent. By discharging by means of a nozzle, a uniform distribution of the suspension of material comprising fibers can be achieved inside the mold. By applying UV infrared radiation, electron radiation, alternating magnetic fields and/or a plasma, uniform curing of the suspension can be achieved and shrinkage of the container during the curing process can be avoided. Subjecting positive pressure to the interior ensures that the suspension is fixed to the inside of the mold and aids the curing process as the liquid phase is forced out of the suspension of material comprising fibers.

In one embodiment of the method, the first subcomponent is displaced based on a geometry of the container and/or a distribution of the suspension of material comprising fibers in the mold. By the targeted displacement of the first subcomponent in the mold, an even more uniform curing of the suspension of material comprising fibers can be achieved, which can increase the quality of the containers produced.

In one embodiment of the method, the second component comprises a bladder or preform which is introduced into the interior of the mold and subjected to positive pressure to cure the suspension introduced into the mold. By subjecting positive pressure to the bladder or preform in the mold, a liquid phase contained in the suspension of material comprising fibers can be removed particularly efficiently and the material comprising fibers can be pressed out to form a container.

In one embodiment of the method, the container produced by the first apparatus is transferred from the first apparatus to the second apparatus by means of the bladder or preform inserted into the interior of the container. This enables particularly gentle gripping and transferring of the containers produced, thus avoiding damage to the containers. Further, a mandrel or equivalent device for gripping and transferring the containers is not required.

In one embodiment of the method, the treating step comprises coating the container by a third component of the second apparatus and/or filling the container with a liquid by a fourth component of the second apparatus and/or labeling the container by a fifth component of the second apparatus and/or sealing the container by a sixth component of the second apparatus. By applying a coating, a barrier can be created between containers of material comprising fibers and a product located in the container. The barrier makes it possible to prevent the product from softening the material of the container comprising cured fibers.

In one embodiment, a container opening is closed with a first cap of material comprising cured fibers to seal the container opening, and subsequently a second cap of material comprising uncured fibers is pressed onto the first cap by means of a pressing tool to seal the container opening. This two-step process allows the container opening to be closed more securely without material comprising uncured fibers entering the container filled with the product.

In one embodiment, certain treatment steps may be performed simultaneously at least some of the time, e.g., coating and drying.

It is also conceivable to run a treatment step at least temporarily in parallel or simultaneously with a production step, such that, for example, a bottom area that has already been formed can already be coated and/or dried while the upper part of the container is still being formed (produced).

### BRIEF DESCRIPTION OF THE FIGURES

FIG. 1: Schematic side view of a device for producing and treating a container of material comprising fiber in accordance with one embodiment.

FIGS. 2a and b: Schematic top view of a transport unit for the first and second apparatus in accordance with various embodiments.

FIGS. 3a-f: Schematic representation of the production process of a container made of material comprising fibers, in accordance with one embodiment

### DETAILED DESCRIPTION OF THE FIGURES

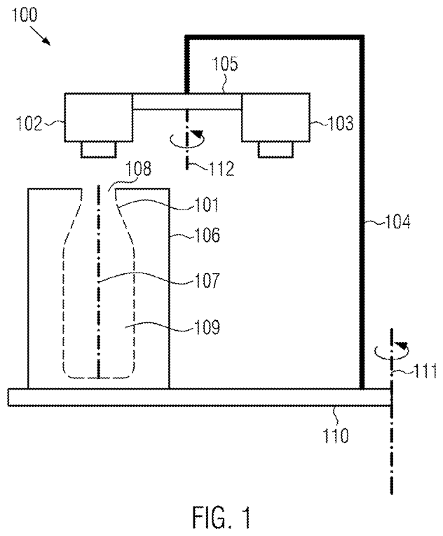

FIG. 1 shows a device 100 for producing and treating a container of material comprising fibers in a mold 106 in accordance with one embodiment. In accordance with the invention, the device 100 comprises first apparatus 102 for performing a production step for producing the container from material comprising fibers and second apparatus 103 for treating the container. In this regard, the second apparatus 103 is configured to perform at least one treatment step on the container. The device further comprises a mold 106 in which the container can be produced at least in part by means of the first apparatus and can be treated at least in part by means of the second apparatus.

In this regard, it is particularly preferred if all of the production comprising all of the production steps and all of the treating comprising all of the treatment steps can be performed by the first and second apparatuses on the container while the container is in or being produced in the mold 106.

By a production step is meant a process step associated with forming the container from a suspension of material comprising fibers and curing it. This comprises, for example, introducing the suspension of material comprising fibers through an opening 108 into the interior 109 of the mold 106 and curing it in the mold 106. Any other process step not related to the introduction of the suspension of material comprising fibers and its curing is to be understood as a treatment step. For example, the treatment step may comprise coating the container, filling the container, labeling the container, and/or sealing the container.

For example, a transport device 110 configured as a carousel may be provided for transporting the mold 106 through the device 100, wherein the carousel may be rotated about an axis of rotation 111. Since production and treatment of the container can be performed in the same mold 106, there is no need to transfer the mold 106 or container between multiple carousels comprising different production or treatment stations for performing the various production and treatment steps. Consequently, the number of necessary carousels or separate production and treatment stations arranged one after the other in the direction of transport can be significantly reduced, allowing the device to be made more compact. Alternatively, a linear operating transport device may be provided for transporting the mold 106 or container through the device 100. A more compact design of the device can also be achieved in the case of a linear operating transport device, since it is not necessary to transfer the mold or container to various production and treatment stations arranged along a transport direction of the transport device.

The mold 106 in which the container is produced and treated comprises an opening 108. For example, through the opening 108, the first apparatus 102 and the second apparatus 103, or at least one or more components of these apparatuses, may be inserted into the interior 109 of the mold 106 to perform a production step or a treatment step. The mold 106 may be produced by means of a generative method. The mold 106 may comprise a metal, preferably a ferromagnetic stainless steel or a coated steel, or any other material, such as a plastic. The mold 106 may be configured to be separable so that the mold 106 can be opened at the end of the production and treatment process and the container can be removed from the mold 106. The mold may comprise a cavity 109 for forming the container, wherein the wall 101 of the cavity 109 may be at least partially perforated or comprise a grid. When the wall 101 of the cavity 109, which is at least partially perforated or designed as a grid, is subjected to negative pressure from the outside or to positive pressure from the inside, the suspension of material comprising fibers introduced into the cavity 109 of the mold 106 can be fixed to the wall 101 of the mold 106 and the curing process of the suspension can be supported by withdrawal of the liquid phase. For example, it may be provided to subject the at least partially perforated wall or the wall designed as a grid from the outside with a negative pressure of 0.1 bar, 0.01 bar or 0.001 bar or to subject the cavity 109 with positive pressure of 2 bar, 5 bar or 10 bar with respect to a prevailing ambient pressure. The application of a lower negative pressure or a higher positive pressure results in a stronger fixation of the suspension comprising fibers to the inside of the mold 106 and also has a beneficial effect on the curing process, since a greater proportion of its liquid phase can be removed from the suspension of material comprising fibers.

In the embodiment shown in FIG. 1, a transport unit 105 comprising the first apparatus 102 and the second apparatus 103 is provided. Here, the transport unit 105 is configured to rotate about an axis of rotation 112, wherein the first apparatus 102 and the second apparatus 103 are configured along the circumference of the transport unit 105 such that they can be alternately placed over the opening 108 of the mold 106 as the transport unit 105 rotates. In the embodiment shown in FIG. 1, the transport unit 105 is arranged in a plane that extends orthogonally to a longitudinal axis of the mold 107. The axis of rotation 112 of the transport unit 105 extends parallel to a longitudinal axis of the mold 107 such that by rotating the transport unit, the first 102 and second apparatus 103 can be alternately placed over the opening 108 of the mold 106. This type of arrangement of the transport unit 105 is to be understood as exemplary. Alternatively, the transport unit 105 may be arranged in a plane that does not extend orthogonally to the longitudinal axis 107 of the mold 106 and may be inclined, for example, at an angle of 5° or 10° or 20° or more to a plane extending orthogonally to the longitudinal axis. For example, an electric motor may be provided to drive the transport unit 105.

The rotatable configuration of the transport unit 105 allows the travel distances of the first 102 and the second apparatus 103, which are necessary to place the two apparatuses alternately over the opening 108 of the mold 106, to be kept short. Thus, the time required for production and treatment can be reduced and a high container throughput can be achieved. The transport unit 105 may be connected to the transport device 110 for transporting the container by means of a connecting apparatus 104 such that the transport unit is moved together with the mold. In one aspect, the connecting apparatus 104 may provide a rigid connection to a part of the carousel. Second, the connecting apparatus 104 allows movement of the transport unit 105 such that the apparatuses 102 and 103 can be positioned over the opening 108.

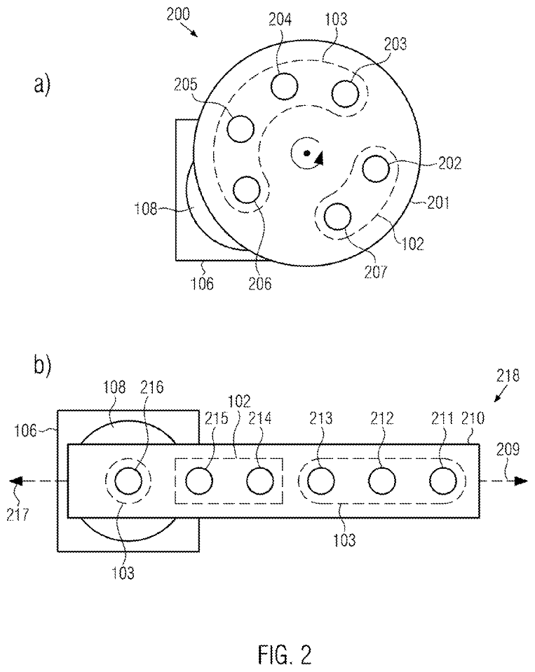

The embodiment of the transport unit 105 described in FIG. 1 is to be understood as exemplary. The transport unit 105 may also be configured as a turret head 200, as, for example, described in connection with FIG. 2a, or as a linear operating transport unit 218, as described in relation to FIG. 2b, or as any other transport unit suitable for alternately placing the first 102 and second apparatus 103 over the opening 108 of the mold 106.

In one embodiment, it may be provided that the carousel 110 comprises a plurality of molds 106 and transport units 105, wherein they are arranged along the circumference of the carousel and each of the molds 106 is associated with exactly one transport unit 105. By placing as many molds 106 and transport units 105 as possible along the circumference of the carousel 110, the highest possible container throughput can be achieved with the device 100.

In one embodiment, an opening of the mold 106 may be provided after all production and treatment steps have been performed by the first apparatus 102 and the second apparatus 103 such that the finished produced and treated container may be removed from the mold 106 and transferred to a downstream device, which may be configured as a second carousel, for example. After transferring the container to the downstream device, another container can be produced and treated in the mold.

In a further embodiment, it may be provided that the first apparatus 102 and the second apparatus 103 are configured to effect the production and treatment steps as a function of an angle of rotation traversed by the carousel. The carousel may comprise a rotation angle control for this purpose. In a more particular embodiment, the first apparatus 102 and the second apparatus 103 may be configured to perform the production and treatment steps during exactly one revolution of the carousel 110. In this way, particularly efficient production and treatment of the containers in terms of time can be achieved, since after each revolution of the carousel, the container produced and treated in a mold 106 can be removed and fed into another device, for example.

FIGS. 2a and b show top views of two alternative embodiments of the transport unit described in FIG. 1.

In FIG. 2a, the transport unit is configured as a turret head 200 comprising a first apparatus 102 for performing a production step of a container of material comprising fibers and a second apparatus 103 for performing a treatment step. In the embodiment shown here, the turret head 200 has a cylindrical shape 201 and can be rotated about an axis of rotation 208. In the embodiment described in FIG. 2a, the axis of rotation 208 of the turret head extends parallel to the longitudinal axis 107 of the mold 106 shown in FIG. 1, so that the first apparatus 102 and the second apparatus 103 can be placed alternately over the opening 108 of the mold 106 to perform the production and treatment steps. Alternatively, however, it may be provided that the axis of rotation 208 of the turret head 208 does not extend parallel to the longitudinal axis 107 of the mold 106. The design type of the turret head 200 as a cylinder shown in FIG. 2a is to be understood as exemplary. The turret head can also have any other suitable shape.

The first apparatus 102 is configured to perform a production step for producing the container in the mold 106. The first apparatus 102 may comprise a first component 207 for discharging a suspension of material comprising fibers through the opening 108 into the interior 109 of the mold 106. To achieve uniform discharging of the suspension of material comprising fibers into the interior 109 of the mold 106, the first apparatus 102 may comprise a nozzle that may be inserted into the interior 109 of the mold 106 through the opening 108 of the mold 106. In one embodiment, it may be provided that the nozzle may be moved both parallel and perpendicular with respect to the longitudinal axis 207 of the mold 106. In a special embodiment, it may also be provided that the nozzle is moved through the interior of the mold according to a travel profile in order to achieve a particularly uniform distribution of the suspension of material comprising fibers in the interior of the mold. The first component can further comprise a bladder or preform that can be inserted into the interior of the mold 106 and can subjected to positive pressure. When positive pressure is applied to the bladder or preform inside the mold 106, the expansion of the bladder or preform can cause the suspension of material comprising fibers to become fixed to the wall 101 of the mold 106. This results in a particularly uniform distribution of the material comprising fibers in the mold 106. Thus, particularly uniformly shaped containers can be produced from material comprising fibers. For example, the bladder or preform can be subjected to a pressure of 1 bar, 2 bar, 5 bar, 10 bar or 50 bar. In one embodiment, the bladder or preform may be provided to remain in the container after the suspension of material comprising fibers has been formed into a container and to form an inner coating of the container. Alternatively, after the suspension of material comprising fibers has been formed into a container, the preform or bladder can be removed from the container.

The first apparatus 102 may further comprise a second component 202 for curing the suspension of material comprising fibers.

The second component 202 may comprise a first subcomponent for exposure to UV radiation, infrared radiation, electron radiation, and/or a plasma. In one embodiment, the first subcomponent may also be configured as or comprise an induction heater. For example, the first subcomponent may be configured as or comprise an induction coil. By applying an alternating current to the induction coil, an alternating magnetic field can be generated by it, such that the first subcomponent can also be configured to be subjected to alternating magnetic fields. In particular, induction heating may be provided when the mold 106 comprises a metallic conductive material, preferably a ferromagnetic material. By subjecting the mold 106 to alternating magnetic fields, electrical eddy currents can be generated in the mold 106, which in turn lead to heating of the mold and thus curing of the suspension of material comprising fibers. It may also be envisaged that the heat generated by alternating magnetic radiation is used for the activation, reaction and/or cross-linking of additives optionally contained in the suspension or of a coating applied to the container, whereby, for example, a gas or liquid barrier may be created in the container and/or other properties of the container may be improved. In one embodiment, it may also be provided that the induction heater is used to clean the mold 106. For example, residues of material comprising fibers present in the mold 106, which may accumulate, for example, in the perforation or grid of the mold 106, can be burned by heating the mold 106 and thus removed. In one embodiment, it may also be provided that the mold is heated with a heat transfer medium, such as oil, to cure the suspension of material comprising fibers. For this purpose, it can be provided, for example, that the mold comprises at least one line through which the heat transfer medium can be guided through the mold. In one embodiment, the first subcomponent may be configured to be inserted through the opening 108 of the mold 106 into the interior 109 thereof. By exposure to UV radiation, infrared radiation, electron radiation, alternating magnetic fields and/or a plasma, uniform curing of the suspension of material comprising fibers can be achieved and in particular shrinkage of the container during the curing process, as is typically the case when applying hot air, can be avoided. In addition, any germs that may be present inside the bottle can be efficiently killed. In order to support the curing process, the first subcomponent can be configured to close the opening of the mold in a vacuum-tight manner and to subject positive pressure to the interior of the mold. Due to the positive pressure applied, the fibers can be fixed to the wall of the mold and the liquid phase of the suspension of material comprising fibers can be pressed out of the mold. For example, the first subcomponent may be configured to apply a positive pressure of 2 bar, 5 bar, or 10 bar to the interior 109 of the mold 106 with respect to a prevailing ambient pressure. A higher positive pressure results in a stronger fixation of the suspension of material comprising fibers to the inside of the mold 106 and also has a beneficial effect on the curing of the suspension of material comprising fibers, since a greater proportion of the liquid phase of the suspension can be forced out of the mold. For this purpose, the first subcomponent can comprise, for example, a bladder or preform as described earlier, which can be inserted into the interior of the mold and subjected to positive pressure. Thus, fixation of the suspension of material comprising fibers to the wall 101 of the mold 106 during curing or drying can also be achieved, thus producing particularly uniformly shaped containers. Optionally, the second component 202 may also be configured to cure the suspension of material comprising fibers by means of hot air. In one particular embodiment, for example, it may be provided to first expose the suspension of material comprising fibers introduced into the mold 106 and/or the mold 106 to UV radiation, infrared radiation, electron radiation, alternating magnetic fields, and/or a plasma and to partially cure the material comprising fibers. Subsequently, the application of heat may be provided for final curing.

To control and monitor the curing of the suspension of material comprising fibers in the mold by means of the second component 202, the mold 106 may be placed on a scale. By determining the weight of the mold during curing, a liquid fraction of the suspension of material comprising fibers, such as a water fraction, can be determined and thus the curing process of the suspension of material comprising fibers can be monitored. Based on the weight of the mold 106, for example, it can be determined when the curing process of the suspension of material comprising fibers in the mold 106 is complete.

In one embodiment, it may be provided that the produced container is transferred from the first apparatus 102 to the second apparatus 103 by means of the bladder or preform optionally inserted into the interior of the container. The bladder or preform can be subjected to a pressure of 0.1 bar to 3 bar for transfer, for example. However, the bladder or preform can be subjected to any other pressure. This enables particularly gentle gripping and transferring of the containers produced, thus avoiding damage to the containers. Further, a mandrel or equivalent device for gripping and transferring the containers is not required. Such a device may nevertheless optionally be provided.

The second apparatus 103 is configured to perform a treatment step on the container. For this purpose, the second apparatus 103 may comprise different components configured to perform different types of treatment steps, such as a coating, a filling, a labeling, or a sealing of the container. In the embodiment described in FIG. 2a, the second apparatus 103 comprises a third component 203 for coating the container, a fourth component 204 for filling the container, a fifth component 206 for labeling the container, and/or a sixth component 205 for sealing the container. Alternatively, the fifth component may be a direct printing device. The direct printing device may comprise a curing unit for curing the printing inks applied by means of the direct printing device on the container surface. For example, the curing unit may comprise a UV light source and/or a thermal radiation source. The fifth component can optionally also be designed for labeling and printing the container.

Again, a transfer of the container between the various components of the second apparatus 103, for example from the third component to the fourth component or between all other components of the second apparatus 103, may be accomplished by means of the bladder or preform. Also a removal of the finished container from the second apparatus, or from its last component, can be realized by means of the bladder or preform.

The third component 203 may comprise, for example, a nozzle configured to be guided through the opening 108 of the mold 106 into the interior 109 thereof to coat the interior of the container being formed therein. By discharging the coating by means of a nozzle, the coating can be evenly distributed on the inside of the container. The coating may serve as a barrier between the container surface made of the material comprising fiber and a product located in the container. By applying the coating to the inside of the container, in particular softening of the container by a liquid product can be avoided. For example, the coating may be polyethylene or comprise polyethylene. However, the coating may also comprise any other material suitable for use as a barrier between the container wall comprising the fiber and the product located in the container.

The fourth component 204 may comprise, for example, a filling nozzle for filling a product into the container and may be connected by means of a supply line to a storage tank in which the product is contained. The fourth component is configured to insert the filling nozzle into a container opening to dispense the product into the interior of the container. The fourth component may also be configured to apply a negative pressure to the interior of the container produced in the mold before the product is filled into the interior of the container by means of the filler neck, thereby allowing the container to be filled with the product more efficiently.

The fifth component 206 may comprise, for example, a robot configured to place a permeable label into the interior 109 of the mold 106 prior to the introduction of the suspension of material comprising fiber by the first component of the first apparatus 102. Subsequently, provision may be made for introducing the suspension of material comprising fibers into the mold 101 and for curing the suspension of material comprising fibers by means of the first apparatus 102. Due to the permeable design of the label, the liquid phase of the suspension comprising fibers can pass through the label when the interior of the mold 101 is subjected to a positive pressure or when the cavity 104 is subjected to a negative pressure, whereby uniform and complete curing of the container can be achieved even in the area where the label is applied. The curing of the suspension of material comprising fibers bonds the material comprising fibers to the permeable label such that the label is securely fixed to the container. In one embodiment, it may be provided that the fifth component is arranged outside the transport unit.

Alternatively, the fifth component 206 may also be configured, for example, to introduce a non-permeable label into the mold by means of a robot prior to the introduction of the suspension of material comprising fibers by the first component 207 of the first apparatus 102. Subsequently, the suspension of material comprising fibers may be discharged into the mold 106. In order to achieve uniform and complete curing of the container, it may be provided that the perforated wall or wall configured as a grid 101 of the mold 106 is subjected to negative pressure from the outside, so that the suspension of material comprising fibers is fixed to the inside of the mold 106 and the liquid phase is withdrawn from the suspension. The curing component may comprise, for example, a perforated surface or a surface configured as a grid which is curved to correspond to the area of the inside of the mold 106 to which the label has been applied and which may be subjected to negative pressure. The perforated surface or surface configured as a grid can subsequently be placed on the area of the container formed in the mold on which the label is applied. The curing component can apply a negative pressure to this area of the inside of the mold and thus achieve curing of the suspension of material comprising fibers even in the area of the non-permeable label. The curing component may further be configured to carry the liquid phase removed from the suspension by the negative pressure out of the mold 106. The curing of the suspension of material comprising fibers bonds the material comprising fibers to the label such that the label is securely fixed to the cured container.

For example, the sixth component 205 may comprise a second subcomponent configured for placing a first cap of material comprising cured fibers in a container opening. The sixth component 205 may further comprise a punch, and be configured to place, by means of the punch, a second cap of material comprising not yet dried out fibers on the container opening and to press the second cap onto the container opening by means of the punch. This allows the bottle to be securely sealed without material comprising fibers entering the bottle during the sealing process and contaminating the product inside.

It may also be provided that the second apparatus 103 comprises other components not explicitly listed herein. For example, the second apparatus 103 may comprise a seventh component configured to clean and/or sterilize the interior of the container after the coating is applied before the product is filled into the interior of the container by the fourth component. Such a component may be provided, in particular, when the container of material comprising fibers is to be filled with a product comprising a food product.

In the embodiment shown in FIG. 2a, the various components of the first 102 and the second apparatus 103 are configured on the cylinder 201 such that, when the cylinder 201 is rotated cyclically in accordance with the direction of rotation shown, the production and treatment steps can be performed in the correct sequence, even if the production and treatment steps alternate at least partially. This allows the turret head rotation direction to be maintained during a complete production and treatment cycle, simplifying the control.

Alternatively, it may be provided that the individual components of the first 102 and second apparatus 103 are configured in groups within the turret head 200. Positioning of the respective component over the opening 108 of the mold 106 may then be effected by rotating the turret head in a first direction or in a second direction opposite to the first direction, depending on which treatment or production step is to be performed and when. In this case, positioning can advantageously be effected by an electric motor or servomotor together with an electronic control unit, such as a central control unit of the device (such as a computer), wherein the sequence of the components to be positioned can be stored in a memory associated with the control unit. This design allows easy rearrangement of the sequence of production and treatment steps.

In order to achieve accurate placement of the various components over the mold 106 described in FIG. 1, it is provided that the various components are arranged equidistantly in the radial direction with respect to the axis of rotation 208 of the turret head. In a more particular embodiment, it may further be provided that the various components are movably mounted in the plane extending perpendicular to the axis of rotation 208 of the turret head 200 such that fine alignment of the various components can be performed over the mold. The turret head 200 shown in FIG. 2a is configured such that, during intermittent operation in the direction of rotation shown, the fifth component 206 can first be placed over the opening of the mold to introduce a label through the opening 108 into the interior 109 of the mold 106 and subsequently the first component 207 may be placed over the mold to introduce a suspension of material comprising fibers into the mold 106. By further rotating the turret head along the direction of rotation, the second component 202 can be aligned over the mold to cure the suspension of material comprising fibers in the mold 106. Subsequently, the third component 203 and the fourth component 204 may be placed over the mold to apply a coating to the cured container and to fill the coated container with a product. By further rotating the turret head in the direction of rotation, the sixth component 205 can be aligned over the mold and the container can be sealed. The arrangement of the various components on the turret head shown in FIG. 2a is to be understood as exemplary. The various components can also be arranged on the turret head in other ways, such that the steps just described can also be performed in a different sequence. In an alternative embodiment, other components not explicitly listed herein may also be arranged on the turret head 200.

FIG. 2b shows an alternative embodiment of a transport unit 218 to FIG. 2a, which is configured as a linear transport unit 218. The transport unit 218 comprises a frame 210 on which are arranged a first apparatus 102 for performing a production step and a second apparatus 103 for performing a treatment step. The transport unit 218 may be displaced along a translational axis 209. For this purpose, the transport unit 218 can be arranged on rails, for example, and moved along the transport direction 209 on the rails by means of an electric motor. The electric motor can be configured as a linear drive, for example. The translational axis 209 does not extend parallel to the longitudinal axis 107 of the mold 106 shown in FIG. 1, allowing the first 102 and second apparatus 103 to be placed over the mold 106 described in FIG. 1. Preferably, the translational axis 209 extends orthogonally to the longitudinal axis 107 of the mold 106. In the embodiment shown herein, the first apparatus 102 comprises a first component 215 for discharging a suspension of material comprising fibers and a second component 214 for curing the suspension of material comprising fibers. The second apparatus 217 comprises a third component 213 for coating the container, a fourth component 212 for filling the container, a fifth component 216 for labeling the container, and a sixth component 211 for sealing the container. The various components can be configured according to the embodiments described for FIG. 2a.

Preferably, the various components of the first 102 and second apparatus 103 are arranged on the frame in such a way that the various production and treatment steps can be performed as the frame is displaced along one of the two directions of the drawn translational axis 209. A time-consuming alternate displacing of the frame along one direction and the other of the translational axis 209 is therefore not necessary. Alternatively, the components can be arranged in groups according to the embodiment of FIG. 2a and by moving the frame by means of suitable control as described in FIG. 2a, a flexible positioning can be effected by a movement of the frame in a first direction and a second direction opposite to the first direction. The arrangement of the various components on the frame shown in FIG. 2b, when the sixth component 216 is initially placed over the opening 108 of the mold 106 and the frame is subsequently displaced along the direction of the translational axis 209 indicated by the reference sign 217, allows first a label to be applied to the mold, subsequently the two production steps to be performed by means of the first and second components, and then the container produced in the mold 106 to be coated by means of the third component, filled by means of the fourth component, and sealed by means of the sixth component. In one embodiment, it may be provided that the various components are movably mounted in a plane extending parallel to the direction of translation 209 of the transport unit 218 such that fine adjustment of the components can be performed over the opening 108 of the mold 106. The arrangement of the various components shown in FIG. 2b is to be understood as exemplary. The various components can also be arranged in a different order so that the production and treatment steps can also be performed in a different sequence. In one embodiment, it may further be provided that not all of the components 211-216 shown in FIG. 2b are arranged on the frame. In an alternative embodiment, other components not explicitly listed herein may also be arranged on the transport unit 218.

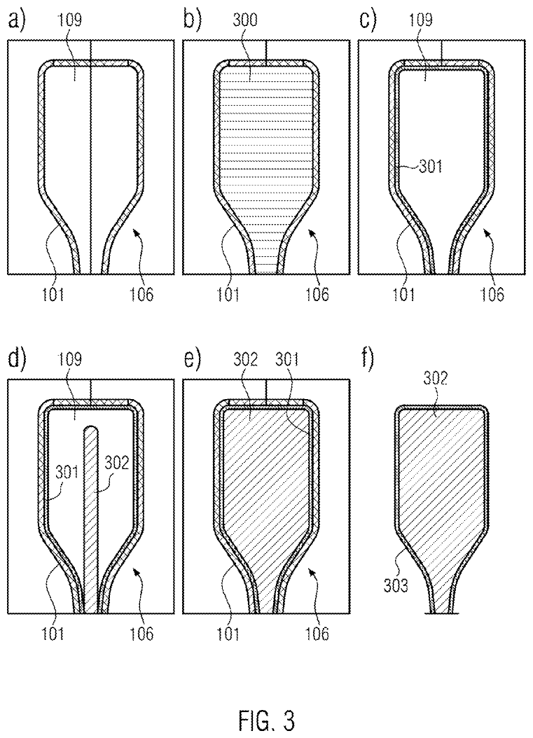

FIGS. 3a-f schematically show the production process of a container in accordance with one embodiment. The production process shown schematically in FIGS. 3a-f can be performed using the device 100 described in FIG. 1 and the embodiments of the transport unit 200 and 218 shown in FIGS. 2a and b, respectively.

FIG. 3a shows a side view of a mold 106 for producing a container of material comprising fibers. The mold may comprise a cavity 109 having a wall 101 for forming the container. Various embodiments of the mold 106 have already been described in detail in relation to FIG. 1, to which reference is made here.

As shown in FIG. 3b, in a first step, the cavity 109 of the mold 106 may be subjected to a suspension of material comprising fibers 300. Subjecting the cavity 109 of the mold 106 to the suspension of material comprising fibers 300 may be performed as described in relation to FIGS. 1 and 2a and b, using the first apparatus 102 to perform a production step for producing the container of material comprising fibers.

To achieve accumulation of the suspension of material 301 comprising fibers on the wall 101 of the mold 106, as shown in FIG. 3c, the interior 109 of the mold 106 may be subjected to positive pressure. This may be accomplished, for example, by the first subcomponent of the first apparatus 102 described in relation to FIGS. 2a and b. Alternatively, or in addition, for accumulation of the suspension of material comprising fibers 301 on the wall 101 of the mold 106, the outer sides of the mold 106 can also be subjected to negative pressure.

In a next step, as shown in FIG. 3d, a bladder 302 or preform 302 may be inserted into the interior 109 of the mold 106. The bladder 302 or preform 302 may comprise a coating material and may be provided not only for forming, but also for coating, the interior of the container produced in the mold 106. For this purpose, the bladder 302 or the preform 302 may bond to the inside of the container during curing of the container and remain in the container as an internal coating after curing. For example, a gas or liquid barrier can be created inside the container by means of the coating material. Alternatively, the bladder 302 or preform 302 may comprise an elastically reversibly deformable material and may be provided only for forming the container and may be removed from the interior of the container after the forming process.

As shown in FIG. 3e, by applying a positive pressure to the bladder 302 or preform 302, the suspension of material comprising fibers 301 attached to the wall 101 of the mold 106 can be pressed into a container and dried. By pressing the bladder 302 or preform 302 against the suspension of material comprising fibers attached to the wall 101 of the mold 106, the bladder 302 or preform 302, if provided as an internal coating, may bond with the attached suspension of material comprising fibers 301 during curing and form an internal coating of the final cured container. In this case, the bladder 302 or preform 302 may remain in the interior of the container as an internal coating after the suspension has cured. If the bladder or preform comprises an elastically reversible material and is not provided as an internal coating, it can also be removed from the interior of the container after the container has cured. In this context, reference is also made to the figure description of FIGS. 2a and b, where the curing of the container of material comprising fibers by means of the bladder or preform is described in more detail.

As shown in FIG. 3f, once the container 303 is fully cured, the mold 106 may be removed from the container. The bladder 302 or preform 302 may remain in the container as an internal coating as described above. Even if the bladder or preform is made of an elastically reversible material and is not provided as an internal coating, they can still be subjected to positive pressure after the mold is opened and remain in the fully cured container. This may be provided, for example, to transfer the container from the first apparatus 102 to the second apparatus 103 by means of the bladder or preform as described in relation to FIGS. 1 and 2a and b, or to transfer the container between the various components of the second apparatus 103. By means of the bladder 302 or preform 302, particularly gentle gripping and transferring of the produced containers can be achieved, thus avoiding damage to the containers. Further, a mandrel or equivalent device for gripping and transferring the containers is not required. Such a device may nevertheless optionally be provided. A transfer of the container from the first apparatus 102 to the second apparatus 103 by means of the preform or bladder may also be provided when the bladder or preform remains in the container as a coating.

1. A device for producing a container from a material comprising fibers and for treating the container, wherein the device comprises a mold, a first apparatus for performing at least one production step for producing the container from the material comprising fibers in the mold, and a second apparatus for performing at least one treatment step for treating the container, and wherein the second apparatus is configured to treat the container in the mold.

2. The device according to claim 1, wherein the first apparatus and the second apparatus are movable in a plane extending perpendicular to a longitudinal axis of the mold to be able to be alternately positioned over the mold to perform the at least one production step and the at least one treatment step.

3. The device according to claim 2, wherein a transport unit is provided comprising the first apparatus and the second apparatus, and wherein the transport unit can be rotated about an axis parallel to the longitudinal axis, and/or wherein the transport unit can be displaced along an axis not extending parallel to the longitudinal axis) to be able to be alternately positioned over the mold to perform the at least one production step and the at least one treatment step.

4. The device according to claim 1, wherein the first apparatus comprises a first component for discharging a suspension of material comprising fibers into the mold, and a second component for curing the suspension of material comprising fibers discharged into the mold, wherein the first component optionally comprises a nozzle for discharging the suspension of material comprising fibers into the mold, and/or wherein the second component for curing the suspension of material comprising fibers optionally comprises a first subcomponent for exposure to UV radiation, infrared radiation, electron radiation, alternating magnetic fields, and/or a plasma, wherein the first subcomponent is further optionally configured to subject an interior of the mold with a positive pressure, wherein the mold optionally comprises an opening, and wherein the nozzle and the first subcomponent are configured to be guided through the opening into the interior of the mold.

5. The device according to claim 4, wherein the second component comprises a bladder or a preform which can be inserted into the interior of the mold and can be subjected to positive pressure to cure the suspension introduced into the mold.

6. The device according to claim 5, wherein the container produced by the first apparatus can be transferred from the first apparatus to the second apparatus by means of the bladder or preform inserted into the interior of the container.

7. The device according to claim 1, wherein the second apparatus for performing at least one treatment step comprises a third component for applying a coating to the container, a fourth component for filling the container with a liquid, a fifth component for labeling the container, and/or a sixth component for sealing the container.

8. A method of producing a container from a material comprising fibers in a mold and treating the container, wherein the producing comprises at least one producing step performed by a first apparatus and the treating comprises at least one treating step performed by a second apparatus, and wherein the container is in the mold when the at least one treating step is performed.

9. The method according to claim 8, wherein the first apparatus and the second apparatus are moved in a plane extending perpendicular to a longitudinal axis of the mold to be alternately positioned over the mold to perform the at least one producing step and the at least one treating step.

10. The method according to claim 9, wherein a transport unit is provided comprising the first apparatus and the second apparatus, and wherein the transport unit is rotated about an axis extending parallel to the longitudinal axis of the mold, and/or wherein the transport unit is moved along an axis not extending parallel to the longitudinal axis of the mold to alternately position the first apparatus and the second apparatus over the mold to perform the at least one producing step and the at least one treating step.

11. The method according to claim 10, wherein the at least one producing step comprises discharging a suspension of material comprising fibers into the mold by means of a first component of the first apparatus, and curing the suspension of material comprising fibers in the mold by means of a second component of the first apparatus, wherein optionally, for discharging the suspension of material comprising fibers, a nozzle is guided through an opening of the mold into an interior of the mold, and optionally, for curing the suspension of material comprising fibers, a first subcomponent of the first apparatus for exposure to UV radiation, infrared radiation, electron radiation, alternating magnetic fields and/or a plasma is guided through the opening into the interior of the mold; wherein the interior of the mold is further optionally subjected to positive pressure by the first subcomponent, wherein the first subcomponent is optionally displaced based on a geometry of the container and/or based on a distribution of the suspension of material comprising fibers in the mold.

12. The method according to claim 11, wherein the second component comprises a bladder or preform which is inserted into the interior of the mold and subjected to positive pressure to cure the suspension introduced into the mold.

13. The method according to claim 12, wherein the container produced by the first apparatus is transferred from the first apparatus to the second apparatus by means of the bladder or preform inserted into the interior of the container.

14. The method according to claim 9, wherein the at least one treating step comprises coating the container by a third component of the second apparatus, and/or filling the container with a liquid by a fourth component of the second apparatus, and/or labeling the container by a fifth component of the second apparatus, and/or sealing the container by a sixth component of the second apparatus.

15. The method according to claim 14, wherein, for sealing the container, a container opening is sealed with a first cap of material comprising cured fibers, and subsequently, for sealing the container opening, a second cap of material comprising not yet cured fibers is pressed onto the first cap by means of a pressing tool.
